(19) United States
(12) Patent Application Publication
(10) Pub. No.: US 2005/0094726 A1
(43) Pub. Date: May 5, 2005

(54) System for encoding video data and system for decoding video data

(75) Inventor: Jeong-hoon Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/942,093

(22) Filed: Sep. 16, 2004

(30) Foreign Application Priority Data
Oct. 10, 2003 (KR) 2003-70648

(51) Int. Cl. H04N 7/12

(52) U.S. Cl. 375/240.08; 375/240.25; 375/240.01

(57) ABSTRACT

The invention relates to a system for encoding video data and/or a system for decoding video data. The system for encoding video data includes a first encoding unit, a second encoding unit, and a header information generating unit. The first encoding unit encodes input video data according to a predetermined syntax and generates a first bitstream. The second encoding unit encodes input video data according to other syntax that is different from the predetermined syntax and generates a second bitstream. The header information generating unit receives the first bitstream or the second bitstream and adds header information including syntax type information that indicates which syntax is used to encode the first bitstream or the second bitstream to the first bitstream or the second bitstream.

### CROSS-REFERENCE TO RELATED APPLICATION

This application claims the benefit Korean Patent Application No. 2003-70648, filed on Oct. 10, 2003, in the Korean Intellectual Property Office, the disclosure of which is incorporated herein in its entirety by reference.

### BACKGROUND OF THE INVENTION

1. Field of the Invention

The invention relates to a system for encoding and/or decoding video data, and more particularly, to a system for encoding video data that encodes video data according to a plurality of different encoding modes and simultaneously performs scalable encoding using the plurality of different encoding modes, and a system for decoding video data encoded by the system for encoding video data.

2. Description of the Related Art

Video data is encoded by an encoder that supports a predetermined data compression standard, e.g., the moving picture expert group (MPEG) standard, and is then stored in a data storage medium or transmitted through a communication channel in the form of a bitstream.

Scalable bitstreams are bitstreams that reproduce videos with different spatial resolutions or videos with different numbers of reproduced frames per hour, i.e., different temporal resolutions, from one bitstream. The bitstream in the former case is spatially scalable and the bitstream in the latter case is temporally scalable. The scalable bitstream includes base layer data and enhancement layer data.

The spatially scalable bitstream enables a decoder to reproduce videos having quality that is equivalent to the quality of a general television by decoding the base layer data. However, when the decoder decodes the enhancement layer data using the base layer data, the decoder can reproduce videos having quality that is equivalent to that of high definition (HD) TVs.

Conventional video data encoders encode video data according to one syntax and generate bitstreams. The format of the bitstreams is defined by the syntax. Decoders decode input bitstreams according to one syntax and reproduce video. Encoding or decoding of data according to one syntax indicates that only one data compression standard is supported. Thus, the encoders cannot generate bitstreams according to syntaxes that are not supported and the decoders cannot decode bitstreams that are encoded according to syntaxes that are not supported.

Further, encoders that support conventional scalability functions encode base layer data and enhancement layer data according to one syntax and generate bitstreams. Due to improvements in the performance of hardware, such as various data transmission channels, encoders, or decoders, the performance and efficiency of encoding can be improved when base layer data and enhancement layer data are encoded according to different syntaxes, respectively. However, the conventional encoders cannot encode video data according to a syntax other than a predetermined syntax.

### SUMMARY OF THE INVENTION

The invention provides an apparatus and method of encoding video data, which can encode video data according to different encoding modes and perform scalable encoding simultaneously using the different encoding modes.

The invention also provides an apparatus and method of decoding video data, which can decode video data that is encoded according to different encoding modes and video data that is scalable-encoded simultaneously using the different encoding modes.

According to an aspect of the invention, there is provided an apparatus for encoding video data including: a first encoding unit encoding input video data according to a predetermined syntax and generating a first bitstream; a second encoding unit encoding input video data according to other syntax that is different from the predetermined syntax and generating a second bitstream; and a header information generating unit receiving the first bitstream or the second bitstream and adding header information including syntax type information that indicates which syntax is used to encode the first bitstream or the second bitstream to the first bitstream or the second bitstream.

According to another aspect of the invention, there is provided an apparatus for encoding video data including: a first encoding unit encoding input video data according to a predetermined syntax and generating a first bitstream; a second encoding unit encoding input video data according to another syntax that is different from the predetermined syntax and generating a second bitstream; a control unit controlling the first encoding unit and the second encoding unit and generating control information including syntax type information that indicates which syntax is used to encode the first bitstream or the second bitstream; and a data communication unit transmitting the first bitstream or the second bitstream and the control information through a communication channel.

According to another aspect of the invention, there is provided a method of encoding video data including: encoding input video data according to one of a plurality of syntaxes and generating a bitstream; and adding header information including syntax type information that indicates which syntax is used to encode the bitstream data to the bitstream.

According to another aspect of the invention, there is provided a method of encoding video data including: encoding input video data according to one of a plurality of syntaxes and generating a bitstream; generating control information including syntax type information that indicates which syntax is used to encode the bitstream; and transmitting the bitstream and the control information through a communication channel.

According to another aspect of the invention, there is provided an apparatus for decoding video data including: a first decoding unit decoding a bitstream that is decoded according to a predetermined syntax; a second decoding unit decoding a bitstream that is decoded according to another syntax that is different from the predetermined syntax; and a bitstream distinguishing unit distinguishing a syntax of an input stream from a plurality of syntaxes and outputting the input bitstream to one of the first decoding unit and the second decoding unit.

According to another aspect of the invention, there is provided an apparatus for decoding video data including: distinguishing a syntax of an input bitstream from a plurality of syntaxes; and decoding the input bitstream according to the distinguished syntax.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for encoding video data according to a first embodiment of the invention;

FIG. 2 is a block diagram of a first encoding unit shown in FIG. 1;

FIG. 3 is a block diagram of a second encoding unit shown in FIG. 1;

FIG. 4 illustrates control information included in header information of a bitstream according to an embodiment of the invention;

FIG. 5 is a block diagram of a system for encoding video data according to a second embodiment of the invention;

FIG. 6 illustrates an example of control information that shows characteristics of a bitstream;

FIG. 7 is a flowchart illustrating a method of encoding video data according to a third embodiment of the invention;

FIG. 8 is a flowchart illustrating a method of encoding video data according to a fourth embodiment of the invention;

FIG. 9 is a block diagram of an apparatus for decoding video data according to a fifth embodiment of the invention; and

FIG. 10 is a flowchart illustrating a method of decoding video data according to a sixth embodiment of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

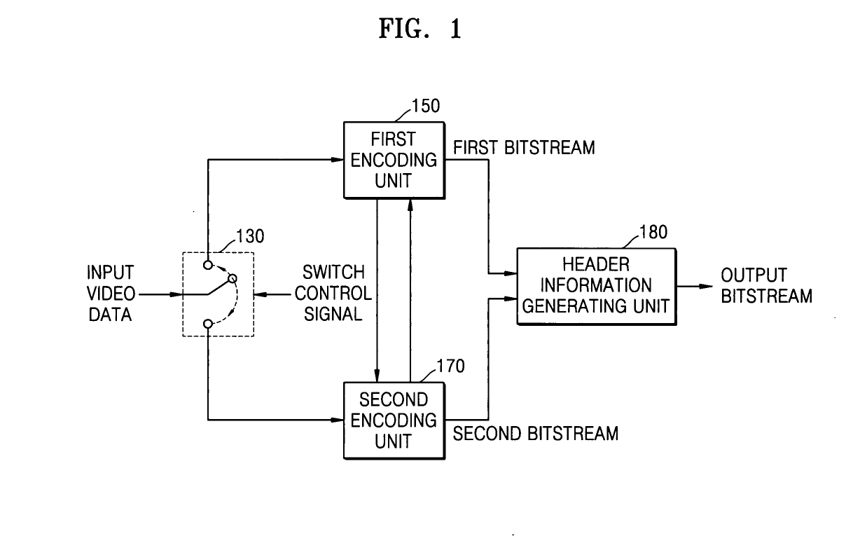

FIG. 1 is a block diagram of an apparatus for encoding video data according to a first aspect of the invention. Referring to FIG. 1, the system includes a switch 130, a first encoding unit 150, a second encoding unit 170, and a header information generating unit 180.

The switch 130 outputs input video data to the first encoding unit 150 or the second encoding unit 170 according to a switch control signal. The switch control signal is output from a control unit (not shown) that controls the overall operation of the system.

The first encoding unit 150 encodes the input video data according to a first encoding mode and outputs a first bitstream according to a first syntax. The second encoding unit 170 encodes the input video data according to a second encoding mode and outputs a second bitstream according to a second syntax. The second syntax is different from the first syntax. The apparatus is not limited to the first and second encoding units.

Operation modes of the first encoding unit 150 and the second encoding unit 170 are set according to a control signal of the control unit (not shown) prior to video data encoding. For example, when the system performs scalable encoding using two different encoding modes, the control unit sets the operation modes of the first encoding unit 150 and the second encoding unit 170 in such a way that the first encoding unit 150 performs base layer data encoding the expression “encodes base layer data” is better and the second encoding unit 170 performs enhancement layer data encoding. The second encoding unit 170 performs enhancement layer data encoding using videos that are previously encoded by the first encoding unit 150 and are then stored.

On the other hand, the operation modes of the first encoding unit 150 and the second encoding unit 170 may be set in such a way that the first encoding unit 150 performs enhancement layer data encoding and the second encoding unit 170 performs base layer data encoding. At this time, the first encoding unit 150 performs enhancement layer data encoding using videos that are previously encoded by the second encoding unit 170 and are then stored. It is understood that each of the encoding units performs encoding of a predetermined layer of data.

Also, when the system performs scalable encoding using one encoding mode instead of two different encoding modes, the operation modes may be set in such a way that one of the first encoding unit 150 and the second encoding unit 170 encodes the input video data. At this time, the switch 130 outputs the input video data only to one of the first encoding unit 150 and the second encoding unit 170 that is set to perform encoding, according to the switch control signal.

The header information generating unit 180 receives the first bit stream output from the first encoding unit 150 or the second bitstream output from the second encoding unit 170 and adds header information including predetermined control information to the received first bit stream or the second bit stream.

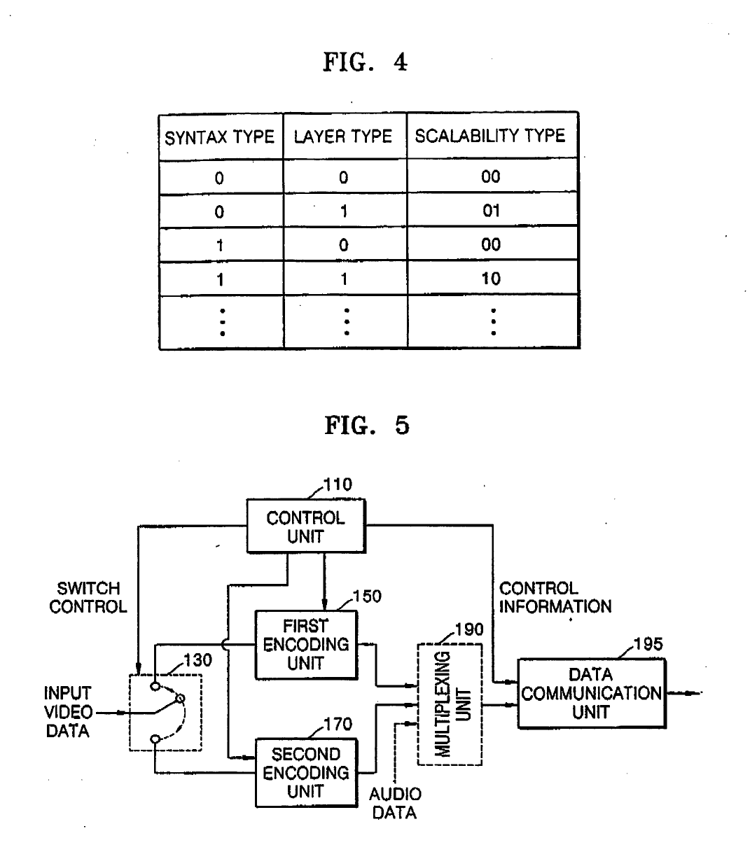

FIG. 4 illustrates an example of control information included in header information of a bitstream. The control information according to the first aspect of the invention has a total of 4 bits. The first bit indicates a syntax type. For example, if the first bit is 0, it indicates a bit stream that is generated by the first encoding unit 150 according to the first syntax. If the first bit is 1, it indicates a bit stream that is generated by the second encoding unit 170 according to the second syntax.

The second bit indicates a layer type. For example, if the second bit is 0, it indicates a bitstream that includes base layer data. If the second bit is 1, it indicates a bit stream that includes enhancement layer data.

The third and fourth bits indicate a scalability type. For example, if the third and fourth bits are 01, the third and fourth bits indicate a temporal-scalable bitstream. If the third and fourth bits are 10, the third and fourth bits indicate a spatial-scalable bitstream. If the third and fourth bits are 00, the third and fourth bits indicate a non-scalable bitstream.

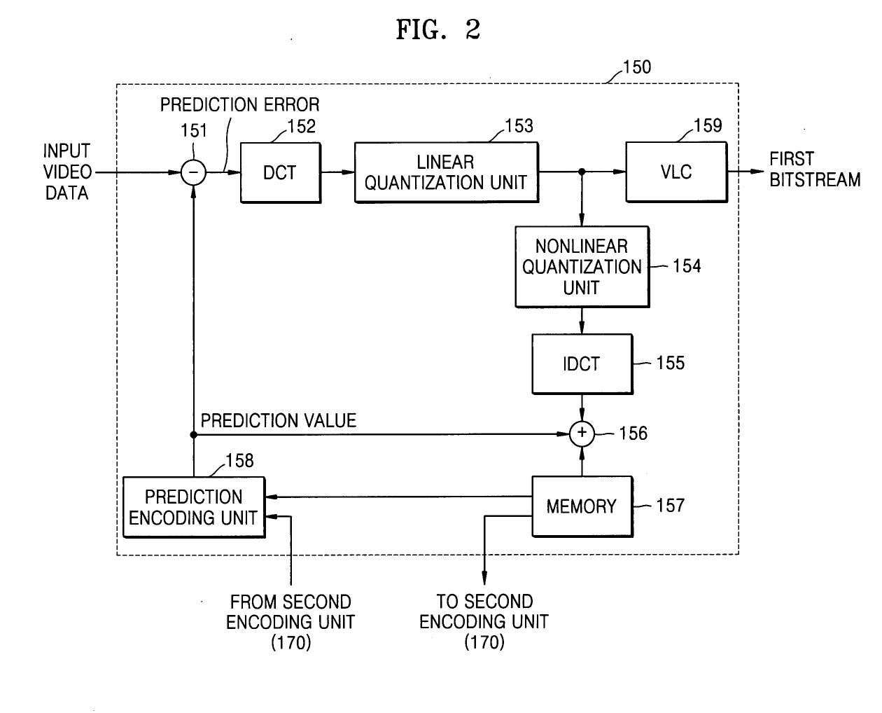

FIG. 2 is a block diagram of the first encoding unit 150 shown in FIG. 1. Referring to FIG. 2, the first encoding unit 150 includes a subtractor 151, a discrete cosine transform (DCT) unit 152, a linear quantization unit 153, an inverse linear quantization unit 154, an inverse DCT unit 155, an adder 156, a memory 157, a prediction encoding unit 158, and a variable length coding (VLC) unit 159.

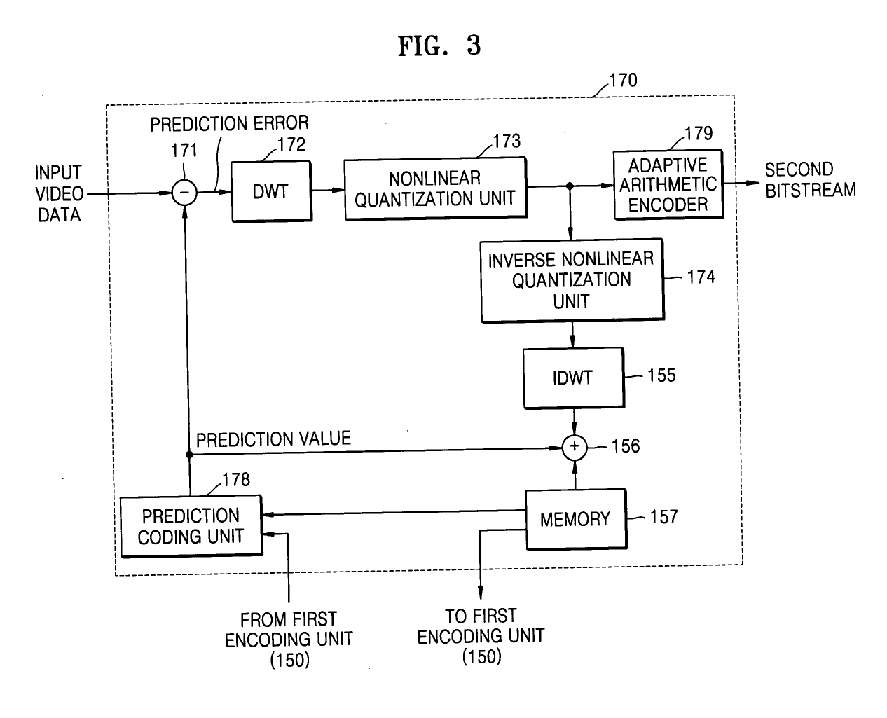

FIG. 3 is a block diagram of the second encoding unit 170 shown in FIG. 1. Referring to FIG. 3, the second encoding unit 170 includes a subtractor 171, a discrete wavelet transform (DWT) unit 172, a nonlinear quantization unit 173, an inverse nonlinear quantization unit 173, an inverse DWT unit 175, an adder 176, a memory 177, a prediction encoding unit 178, and an adaptive arithmetic encoder 179.

Since the first encoding unit 150 and the second encoding unit 170 encode video data according to different encoding modes, their detailed structures are different from each other. Referring to FIGS. 2 and 3, in terms of transform of the input video data, the first encoding unit 150 uses DCT, but the second encoding unit 170 uses DWT. In terms of quantization, the first encoding unit 150 adopts linear quantization, but the second encoding unit 170 adopts nonlinear quantization. In terms of entropy encoding, the first encoding unit 150 adopts VLC, but the second encoding unit 170 adopts adaptive arithmetic encoding.

The prediction encoding units 158 and 178 each perform motion estimation and compensation and may use different algorithms for motion estimation and compensation. For example, the prediction encoding unit 158 of the first encoding unit 150 may perform motion estimation and compensation in units of a 16×16 macroblock, but the prediction encoding unit 178 of the second encoding unit 170 may perform motion estimation and compensation in units of not only a 16×16 macroblock that is introduced in H.264 but also a sub-block of various sizes such as 4×4, 8×4, 4×8, 8×8, 16×8, and 8×16, and the like.

The first encoding unit 150 and the second encoding unit 170 shown in FIGS. 2 and 3 are examples of encoders that perform encoding according to different modes and may be implemented using various encoding modes. For example, the first encoding unit 150 may support MPEG-4 part 2 video part specifications and the second encoding unit 170 may support MPEG-4 part 10 Advanced Video Coding (AVC).

FIG. 5 is a block diagram of a system for encoding video data according to a second aspect of the invention. Referring to FIG. 5, the system includes a control unit 110, a switch 130, a first encoding unit 150, a second encoding unit 170, and a data communication unit 195. Further, when audio data that is related to video data is encoded by an audio encoder (not shown), the system may further include a multiplexing unit 190 that receives the encoded video data and audio data and multiplexes them.

For example, the system according to the second aspect of the invention shown in FIG. 5 is included in a mobile terminal, performs real-time encoding of video data, and transmits the encoded data to other mobile terminal or other device is through a wired or wireless communication channel.

The system according to the first aspect of the invention adopts an in-band approach in which control information, such as syntax type information and layer information, is included in header information of a bitstream. However, the system according to the second aspect of the invention shown in FIG. 5 adopts an out-of-band approach in which control information is transmitted through a separate communication channel from a communication channel through which a bitstream is transmitted.

Hereinafter, the operation of the system according to the second aspect of the invention will be described in detail with reference to FIG. 5. In FIG. 5, the switch 130 outputs input video data to the first encoding unit 150 or the second encoding unit 170 according to a switch control signal output from the control unit 110.

The first encoding unit 150 encodes the input video data according to a first encoding mode and outputs a first bitstream according to a first syntax. The second encoding unit 170 encodes the input video data according to a second encoding mode and outputs a second bitstream according to a second syntax. The first encoding unit 150 and the second encoding unit 170 may be implemented as shown in FIGS. 2 and 3, respectively. Operation modes of the first encoding unit 150 and the second encoding unit 170 are set according to a control signal of the control unit 110 prior to video data encoding.

The control unit 110 controls the overall operation of the system according to the second aspect of the invention. Also, the control unit 110 generates control information that indicates the characteristic of the bitstream generated by the first encoding unit 150 or the second encoding unit and outputs the generated control information to the data communication unit 195. The control information includes at least a syntax type, a layer type, and a scalability type of the generated bitstream.

The data communication unit 195 receives the first bitstream output from the first encoding unit 150 or the second bitstream output from the second encoding unit 170 or the multiplexed bitstream and transmits the same to a reception-side device (not shown) through a predetermined communication channel. Also, the data communication unit 195 receives the control information indicating the characteristic of the first bitstream or the second bitstream from the control unit 110 and transmits the same to a reception-side device (not shown) through a communication channel that is different from a communication channel through which the bitstream is transmitted.

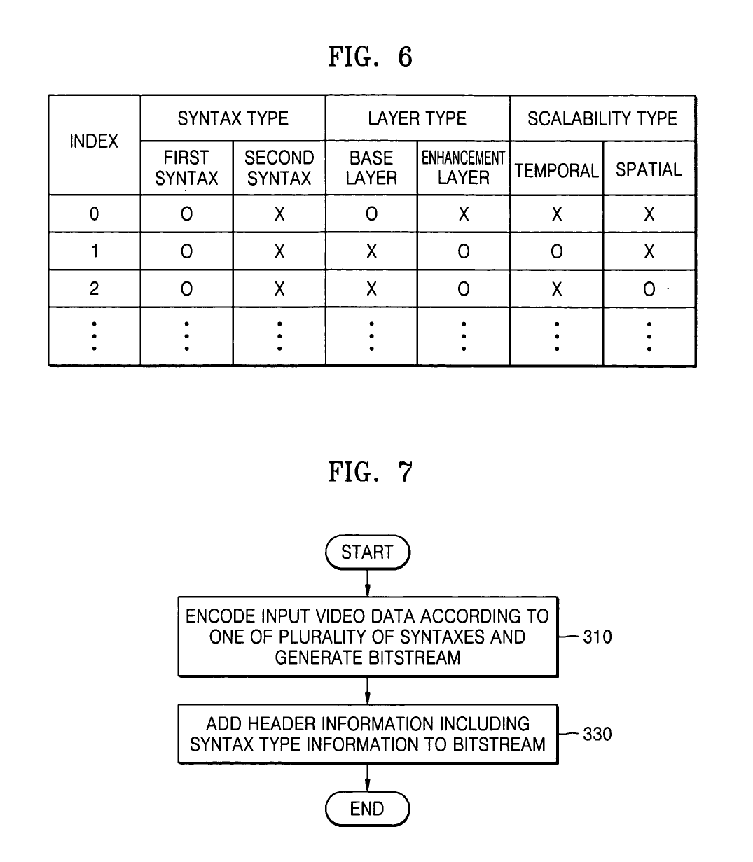

FIG. 6 illustrates control information that indicates the characteristic of a bitstream. The control information according to the second aspect of the invention is indexed according to a syntax type, a layer type, and a scalability type of a bitstream. Referring to FIG. 6, an index “0” indicates a bitstream that is generated by the first encoding unit 150 according to the first syntax and includes base layer data. An index “1” indicates a bitstream that is generated by the first encoding unit 150 according to the first syntax, includes enhancement layer data, and is temporally scalable. An index “2” indicates a bitstream that is generated by the first encoding unit 150 according to the first index, includes enhancement layer data, and is spatially scalable.

The indexed control information may be error correction coded to handle a channel error.

FIG. 7 is a flowchart illustrating a method of encoding video data according to a third aspect of the invention. The method shown in FIG. 7 is performed by the system shown in FIG. 1. In operation 310, input video data is encoded according to one of a plurality of syntaxes and then a bitstream is generated. Prior to operation 310, preset is performed such that base layer data encoding is performed according to one of the plurality of syntaxes and enhancement layer data encoding is performed according to another syntax.

In operation 330, header information including syntax type information that indicates which syntax is used to encode the input video data is added to the generated bitstream. The header information further includes layer type information that indicates whether the generated bitstream is base layer data or enhancement layer data or scalability type information that indicates the generated bitstream is spatially scalable or temporally scalable.

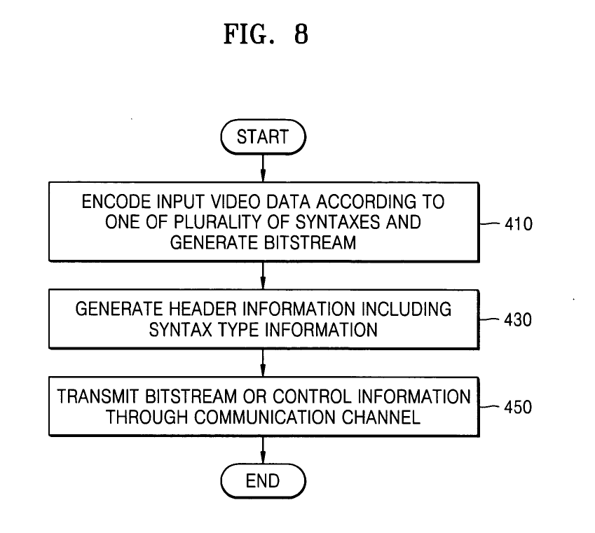

FIG. 8 is a flowchart illustrating a method of encoding video data according to a fourth aspect of the invention. The method shown in FIG. 8 is performed by the system shown in FIG. 5.

In operation 410, input video data is encoded according to one of a plurality of syntaxes and a bitstream is generated. Prior to operation 410, preset is performed such that base layer data encoding is performed according to one of the plurality of syntaxes and enhancement layer data encoding is performed according to another syntax.

In operation 430, control information including syntax type information that indicates which syntax is used to encode the input video data is generated. The control information indicates the characteristic of the generated bitstream, and preferably, further indicates a layer type and a scalability type in addition to the syntax type. The control information may be expressed as information indexed according to the syntax type, the layer type, and the scalability type as shown in FIG. 6.

In operation 450, the generated bitstream and control information are transmitted through a communication channel. In operation 450, the generated bitstream may be transmitted through a predetermined communication channel and the generated control information may be transmitted through a separate communication channel from the predetermined communication channel.

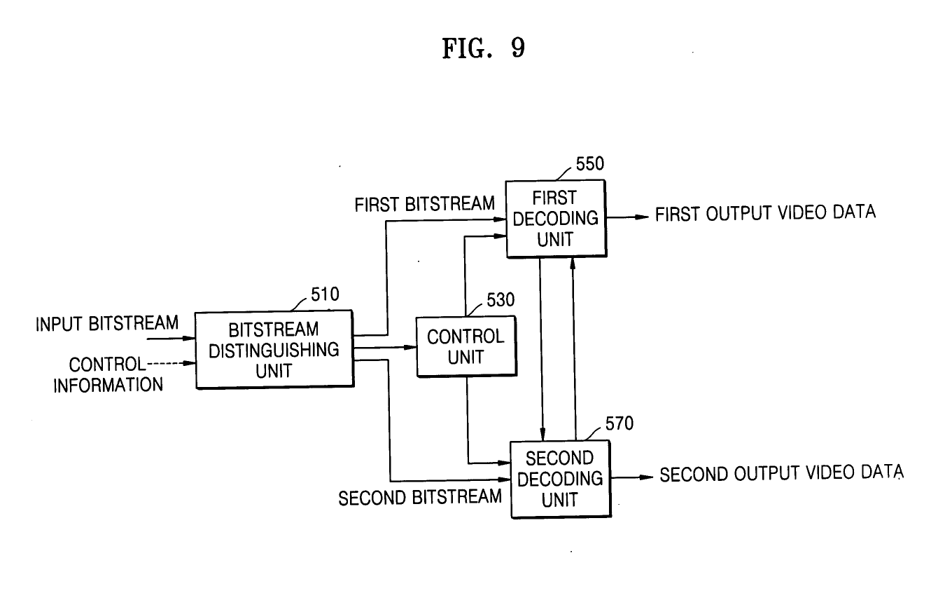

FIG. 9 is a block diagram of an apparatus for decoding video data according to a fifth aspect of the invention. Referring to FIG. 9, the system includes a bitstream distinguishing unit 510, a control unit 530, a first decoding unit 550, and a second decoding unit 570.

The system according to the third aspects of the invention includes the first decoding unit 550 and the second decoding unit 570 that decode bitstreams according to different decoding modes in order to decode video data that is encoded according to different encoding modes. The system is able to decode video data that is scalable-encoded according to different encoding modes.

When a bitstream is input, the control unit 530 sets operation modes of the first decoding unit 550 and the second decoding unit 570 according to control information included in a head of the input bitstream. An example of the control information included in the head of the input bitstream is shown in FIG. 4. For example, when the control information is “0000”, the control information that indicates a bitstream is generated according to the first syntax and includes base layer data. Thus, the control unit 530 sets the operation mode of the first decoding unit 550 such that the first decoding unit 550 performs base layer decoding.

When the control information is “1110”, the control information indicates that a bitstream is generated according to the second syntax, includes enhancement layer data, and is spatially scalable. Thus, the control unit 530 sets the operation mode of the second decoding unit 570 such that the second decoding unit 570 performs spatial-scalable decoding of enhancement layer data.

Control information that controls the characteristic of the input bitstream and the operation of a decoder may be transmitted to the decoder through a communication channel that is separate from the input bistream according to an out-band approach, instead of adding the control information to the head of the input bitstream. An example of the control information transmitted to a decoder according to the out-band approach is shown in FIG. 6. The control unit 530 receives indexed control information and sets the operation modes of the first decoding unit 550 and the second decoding unit 570 according to the received control information.

Once the operation mode of the first decoding unit 550 or the second decoding unit 570 is set, the bitstream distinguishing unit 510 distinguishes a syntax used to encode the input video data from the plurality of syntaxes and outputs the input bitstream to one of the first decoding unit 550 and the second decoding unit 570.

The first decoding unit 550 or the second decoding unit 570 that receives the input bitstream performs decoding in such a manner as the respective first decoding unit 560 or the second decoding unit 570 is initially set. When the control unit 530 sets the operation modes of the first decoding unit 550 and the second decoding unit 570 such that the first decoding unit 550 performs base layer decoding and the second decoding unit 570 performs enhancement layer decoding, the second decoding unit 570 performs enhancement layer decoding using videos that are previously decoded by the decoding unit 550 and are then stored.

On the other hand, the control unit 530 may set the operation modes of the first decoding unit 550 and the second decoding unit 570 such that the first decoding unit 550 performs enhancement layer decoding and the second decoding unit 570 performs base layer decoding. At this time, the first decoding unit 550 performs enhancement layer decoding using videos that are previously decoded by the second decoding unit 570 and are then stored.

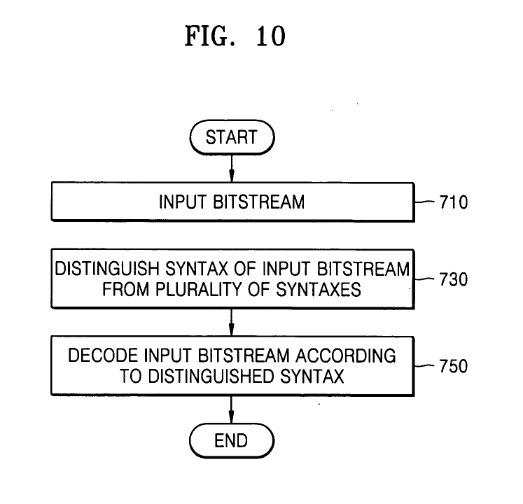

Hereinafter, a method of decoding video data according to a sixth aspect of the invention will be described based on the structure of the system according to the fifth aspect of the invention shown in FIG. 9. FIG. 10 is a flowchart illustrating the method of decoding video data according to a sixth aspect of the invention.

In operation 710, a bitstream is input to the system for decoding video data. The control unit 530 of the system sets the operation modes of the first decoding unit 550 and the second decoding unit 570 according to control information included in a header of the bitstream. The control information includes information that controls the characteristic of the bitstream and the operation of the system. When the control information is transmitted to the system through a communication channel separately from the bitstream according to the out-band approach, instead of adding the control information to the head of the bitstream, the control unit 530 may set the operation modes of the first decoding unit 550 and the second decoding unit 570 according to the received control information.

When the operation modes of the first decoding unit 550 and the second decoding unit 570 are set, the bitstream distinguishing unit 510 distinguishes a syntax of the input bitstream from a plurality of syntaxes in operation 730.

In operation 750, the input bitstream is output to one of the first decoding unit 550 and the second decoding unit 570 according to the syntax distinguished in operation 730 and the first decoding unit 550 or the second decoding unit 570 that receives the input stream performs decoding in such a manner as is initially set.

As described above, conventional video data encoders generate a bitstream by performing encoding or scalable encoding of video data according to one syntax and conventional decoders reproduce videos by performing decoding or scalable decoding of input bitstreams according to one syntax. However, the system for encoding video data according to an aspect of the invention independently encodes video data according to different encoding modes and performs scalable encoding simultaneously using different encoding modes. Also, the system for decoding video data according to an aspect of the invention decodes video data that is encoded according to different encoding modes and video data that is scalable-encoded simultaneously using different encoding modes. Moreover, since video data is encoded/decoded or scalable-encoded/scalable-decoded using a more suitable encoding mode that is selected from among different encoding modes based on the hardware performance or data communication environment, the efficiency of encoding and image quality are improved and a variety of application services are provided.

Meanwhile, an aspect of the invention can be embodied as a computer readable code on a computer readable recording medium. The computer readable recording medium is any data storage device that can store data that can be thereafter read by. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus for encoding video data, comprising:
a first encoding unit that encodes input video data according to a predetermined syntax and generates a first bitstream;
a second encoding unit that encodes input video data according to another syntax that is different from the predetermined syntax and generates a second bitstream; and
a header information generating unit that receives the first bitstream or the second bitstream and adds header information including syntax type information that indicates which syntax is used to encode the first bitstream or the second bitstream to the first bitstream or the second bitstream.

2. The apparatus as claimed in claim 1, wherein the first encoding unit or the second encoding unit performs base layer data encoding or enhancement layer data encoding in a predetermined manner.

3. The apparatus as claimed in claim 1, wherein the header information further includes layer type information that indicates whether the first bitstream or the second bitstream is base layer data or enhancement layer data.

4. The apparatus as claimed in claim 1, wherein the header information further includes scalability type information that indicates the first bitstream or the second bitstream is spatially scalable or temporally scalable.

5. A method of encoding video data comprising:
encoding input video data according to one of a plurality of syntaxes and generating a bitstream; and
adding header information including syntax type information that indicates which syntax is used to encode the bitstream data to the bitstream.

6. The method as claimed in claim 5, wherein in the encoding, base layer data encoding or enhancement layer data encoding is performed in a predetermined manner.

7. The method as claimed in claim 5, wherein the header information further includes layer type information that indicates whether the bitstream is base layer data or enhancement layer data.

8. The method as claimed in claim 5, wherein the header information further includes scalability type information that indicates the bitstream is spatially scalable or temporally scalable.

9. An apparatus for encoding video data comprising:
a first encoding unit that encodes input video data according to a predetermined syntax and generates a first bitstream;
a second encoding unit that encodes input video data according to another syntax that is different from the predetermined syntax and generates a second bitstream;
a control unit that controls the first encoding unit and the second encoding unit and generates control information including syntax type information that indicates which syntax used to encode the first bitstream or the second bitstream; and
a data communication unit that transmits the first bitstream or the second bitstream, and the control information through a communication channel.

10. The apparatus as claimed in claim 9, wherein the data communication unit transmits the first bitstream or the second bitstream through a predetermined communication channel and transmits the control information through a separate channel from the predetermined communication channel.

11. The apparatus as claimed in claim 9, wherein the first encoding unit or the second encoding unit performs base layer data encoding or enhancement layer data encoding in a predetermined manner.

12. The apparatus as claimed in claim 9, wherein the control information further includes layer type information that indicates whether the first bitstream or the second bitstream is base layer data or enhancement layer data.

13. The apparatus as claimed in claim 9, wherein the control information further includes scalability type information that indicates the first bitstream or the second bitstream is spatially scalable or temporally scalable.

14. A method of encoding video data comprising:
encoding input video data according to one of a plurality of syntax and generating a bitstream;
generating control information including syntax type information that indicates which syntax is used to encode the bitstream from among the plurality of syntax; and
transmitting the bitstream and the control information through at least one channel.

15. The method as claimed in claim 14, further comprising:
transmitting, the bitstream through a predetermined communication channel; and
transmitting the control information through a separate channel from the predetermined communication channel.

16. The method as claimed in claim 14, wherein in the encoding the input video data, base layer data encoding or enhancement layer data encoding is performed in a predetermined manner.

17. The method as claimed in claim 14, wherein the generated control information further includes layer type information that indicates whether the bitstream is base layer data or enhancement layer data.

18. The method as claimed in claim 14, wherein the generated control information further includes scalability type information that indicates whether the bitstream is spatially scalable or temporally scalable.

19. An apparatus for decoding video data according to an input bitstream, comprising:
a first decoding unit to decode the input bitstream that is encoded according to a first syntax;
a second decoding unit to decode the input bitstream that is encoded according to a second syntax that is different from the first syntax; and
a bitstream distinguishing unit to distinguish a syntax of the input bitstream between the first syntax and the second syntax and output the input bitstream to a corresponding one of the first decoding unit or the second decoding unit.

20. The apparatus as claimed in claim 19, wherein the bitstream distinguishing unit distinguishes the syntax of the input bitstream from the plurality of syntaxes according to control information including syntax type information that indicates which syntax is used to encode the input bitstream.

21. The apparatus of claim 19, further comprising:
a control unit to set an operation mode of the first decoding unit or the second decoding unit to perform decoding corresponding to base layer data or enhancement layer data according to the layer type information,
wherein the control information further includes layer type information that indicates whether video data included in the input bitstream is base layer data or enhancement layer data.

22. The apparatus as claimed in claim 21, wherein the control information further includes scalability type information that indicates whether the input bitstream is spatially scalable or temporally scalable and the control unit receives the scalability type information and sets an operation mode of the first decoding unit or the second decoding unit to perform decoding corresponding to the scalability type information.

23. The apparatus as claimed in claim 20, wherein the control information is included in a head of the input bitstream.

24. The apparatus as claimed in claim 20, wherein the control information is received through another channel that is different from a channel that is used in the transmission of the input bitstream, prior to the transmission of the input bitstream.

25. A method of decoding video data comprising:
distinguishing a syntax of an input bitstream from a plurality of syntaxes; and
decoding the input bitstream according to the distinguished syntax.

26. The method as claimed in claim 25, wherein the syntax of the input bitstream is distinguished from the plurality of syntaxes according to control information including syntax type information that indicates which syntax is used to encode the input bitstream.

27. The method as claimed in claim 26, wherein the control information further includes layer type information that indicates whether video data included in the input bitstream is base layer data or enhancement layer data, and in the decoding the input bitstream, base layer data decoding or enhancement layer data decoding is performed according to the layer type information.

28. The method as claimed in claim 26, wherein the control information further includes scalability type information that indicates whether video data included in the input bitstream is spatially scalable or temporally scalable, and in the decoding the input bitstream, spatial-scalable decoding or temporal-scalable decoding is performed according to the scalability type information.

29. The method as claimed in claim 26, wherein the control information is included in a head of the input bitstream.

30. The method as claimed in claim 26, wherein the control information is received through another channel that is different from a channel that is used in the transmission of the input bitstream, prior to the transmission of the input bitstream.

31. A computer readable recording medium having recorded thereon a program for implementing a method of encoding video data, the method comprising:
encoding input video data according to one of a plurality of syntaxes and generating a bitstream; and
adding header information including syntax-type information that indicates which syntax is used to encode the bitstream to the bitstream.

32. A computer readable recording medium having recorded thereon a program for implementing a method of encoding video data, the method comprising:
encoding input video data according to one of a plurality of syntaxes and generating a bitstream;
generating control information including syntax type information that indicates which syntax is used to encode the bitstream; and
transmitting the bitstream and the control information through at least one communication channel.

33. A computer readable recording medium having recorded thereon a program for implementing a method of decoding video data, the method comprising:
distinguishing a syntax of an input bitstream from a plurality of syntaxes; and
decoding the input bitstream according to the distinguished syntax.

34. An encoding apparatus to encode video data according to a plurality of syntaxes, comprising:
a plurality of encoding units, each of the plurality of encoding units encoding the video data according to a different encoding mode; and
a unit to direct the video data to one of the plurality of encoding units according to a characteristic of the video data,
wherein each of the plurality of encoding modes corresponds with a different syntax.

35. The encoding apparatus as claimed in claim 34, wherein the plurality of encoding units comprises:
a first encoding unit to encode video data according to a predetermined syntax and generate a first bitstream; and
a second encoding unit to encode video data according to a different predetermined syntax from the first encoding unit and generate a second bitstream.

36. The encoding apparatus as claimed in claim 35, wherein one of the first encoding unit or the second encoding unit is an enhancement layer data encoding unit to encode an enhancement layer and the other one of the first encoding unit or the second encoding unit is a base layer data encoding unit to decode a base layer.

37. The encoding apparatus as claimed in claim 36, wherein the base layer data encoding unit transmits a base layer data encoded signal to the enhancement layer data encoding unit for the enhancement layer to be data encoded.

38. The encoding apparatus as claimed in claim 35, further comprising:
a header information generating unit to receive the first bitstream or the second bitstream and add header information to the received bitstream.

39. The encoding apparatus as claimed in claim 36, further comprising:
a header information generating unit to receive the first bitstream or the second bitstream and add header information to the received bitstream,
wherein the header information includes control information indicating whether the first bitstream or the second bitstream is the base layer data or the enhancement layer data, and/or whether the first bitstream or the second bitstream is spatially scalable or temporally scalable.

40. The encoding apparatus as claimed in claim 34, further comprising an encoding unit to encode audio data.

41. The encoding apparatus as claimed in claim 40, further comprising a multiplexing unit to receive the encoded video data and the encoded audio data and multiplex the encoded video data with the encoded audio data.

42. The encoding apparatus as claimed in claim 41, further comprising:
a data communication unit to receive the first bitstream or the second bitstream or the multiplexed bitstream and transmit the received first bitstream or the received second bitstream or the multiplexed bitstream through a predetermined communication channel to a reception device.

43. The encoding apparatus as claimed in claim 35, further comprising:
a data communication unit to receive the first bitstream or the second bitstream and transmit the received first bitstream or the received second bitstream through a predetermined communication channel to a reception device.

44. The encoding apparatus as claimed in claim 35, further comprising:
a control unit to control the first encoding unit and the second encoding unit and generate control information including syntax type information that indicates syntax used to encode the first bitstream or the second bitstream; and
a data communication unit to transmit the first bitstream or the second bitstream and the control information through a communication channel to a reception device,
wherein the control information indicates whether the first bitstream or the second bitstream is the base layer data or the enhancement layer data, and/or whether the first bitstream or the second bitstream is spatially scalable or temporally scalable.

45. The encoding apparatus as claimed in claim 35, wherein the data communication unit transmits the first bitstream or the second bitstream through a predetermined communication channel and transmits control information through a separate channel from the predetermined communication channel.

46. The encoding apparatus as claimed in claim 34, wherein each of the plurality of syntaxes supports a different data compression standard.

47. The encoding apparatus as claimed in claim 34, further comprising a control unit to set the controlling mode for each of the plurality of encoding units.

48. The encoding apparatus as claimed in claim 34, wherein the unit to direct video data is a switch device that outputs video data to one of the plurality of encoding units according to one of the plurality of syntaxes.

49. A decoding apparatus to decode video data that is scalable-encoded according to different encoding modes, comprising:
a plurality of decoding units, each of the plurality of decoding units decoding an input bitstream according to a different decoding mode and outputting video data; and
a unit to distinguish a syntax of the input bit stream from a plurality of syntaxes and output the bitstream to one of the plurality of decoding units according to the distinguished syntax.

50. The decoding apparatus to decode video data as claimed in claim 49, further comprising:
a control unit to set an operation mode for each of the plurality of decoding units according to control information included in the input bitstream, wherein the control unit adds control information to the bitstream.

51. The decoding apparatus to decode video data as claimed in claim 50, wherein the operation mode of one decoding unit is a base layer decoding mode to decode a base layer and the operation mode of another decoding unit is an enhancement layer decoding mode to decode an enhancement layer.

52. The decoding apparatus to decode video data as claimed in claim 51, wherein
the decoding unit set to decode the enhancement layer performs the enhancement layer decoding using the bitstream this is previously decoded by the decoding unit set to decode the base layer.

53. The decoding apparatus to decode video data as claimed in claim 49, further comprising:
a control unit to set an operation mode for each of the plurality of decoding units according to control information that is transmitted to the decoding apparatus through a channel that is separate from the input bitstream included in the input bitstream, wherein the control unit sets the operation mode of each of the plurality of decoding units according to the received control information.

54. The decoding apparatus to decode video data as claimed in claim 53, wherein the operation mode of one decoding unit is a base layer decoding mode to decode a base layer and the operation mode of another decoding unit is an enhancement layer decoding mode to decode an enhancement layer.

55. The decoding apparatus to decode video data as claimed in claim 54, wherein the decoding unit set to decode the enhancement layer performs the enhancement layer decoding using the bitstream this is previously decoded by the decoding unit set to decode the base layer.

56. A system for encoding and decoding video data comprising:
a plurality of encoding and decoding units, each of the plurality of encoding and decoding units correspondingly encoding video data according to a different encoding mode and decoding video data according to a different decoding mode;
a header information generating unit that receives the encoded video data from one of the plurality of encoding units, adds header information to the received encoded video data that includes syntax information that indicates which syntax is used to encode the received encoded video data, and outputs the encoded video data; and
a distinguishing unit to distinguish the syntax of the outputted encoded video data from a plurality of syntaxes and output the video to one of the plurality of decoding units according to the distinguished syntax.
